(19) United States
(12) Patent Application Publication
(10) Pub. No.: US 2008/0286064 A1
(43) Pub. Date: Nov. 20, 2008

(54) Device for deburring end portions of tubes

(76) Inventors: Maurizio Sbetti, Levico Terme (IT); Livio Andreatta, Levico Terme (IT); Renzo Filippi, Levico Terme (IT)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 12/151,134

(22) Filed: May 2, 2008

(30) Foreign Application Priority Data
May 9, 2007 (IT) MI2007A-000939

(51) Int. Cl. B23D 1/00

(52) U.S. Cl. 409/299

(57) ABSTRACT

A device for deburring end portions of tubes, arranged in a horizontal plane, comprises a support body which can be rotatively driven about a pivot axis (X) and supporting pairs of drum brushes rotating about a drum brush pivot axis arranged perpendicular to the support body pivot axis (X), the support body and drum brushes being adapted to be controllably driven on a plane coinciding with a tube end portion to be deburred.

### BACKGROUND OF THE INVENTION

The present invention relates to a device for deburring end portions of tubes.

As is known, cut or milled tubes or pipes present, upon cutting or milling, residual machining burrs at their end portions, which residual burrs may cause problems related to an even storing of the tubes; moreover, said residual burrs may injure an operator performing thereon subsequent manual processing or machining operations.

Thus, it is increasingly required to perfectly deburr the end portions of tubes or pipes cut to any desired length and facilitate further processing operations, to be performed after having cut the tubes, such as collection or measurement and bending operations, thereby preventing said residual burrs from hindering them.

Prior deburring machines performing said deburring operations by manually pressing the workpiece to be deburred against a static drum brush and then by manually rotatively driving the thus pressed workpiece.

In other prior deburring devices, the tube to be brushed is manually pressed by an operator, to provide a satisfactory brushing or deburring of said tube, against a rotary drum brush. Such a manual intervention is also necessary in other prior deburring machines, for example those including two counter-rotating brushes designed for brushing the two end portions of the tube.

In addition to requiring the presence of an operator, all the above prior deburring machines have the further drawback that their deburring brushes wear in a very uneven manner, depending on the diameter of the tube workpiece to be deburred.

### SUMMARY OF THE INVENTION

Accordingly, the aim of the present invention is to provide a novel and improved device for automatically deburring or brushing end portions of tubes or pipes, which overcomes the above mentioned drawbacks of the prior art.

The above aim is achieved by a device for deburring end portions of tubes, arranged in a horizontal plane, said device including a support body rotatively driven about a pivot axis, said support body supporting pairs of drum brushes in turn rotatively driven about a drum brush pivot axis (X), perpendicular to the pivot axis (X) of said support body, said support body and drum brushes being controllably translated in a plane coinciding with an end portion of a tube to be deburred.

Further advantages of the invention will become more apparent from the following disclosure, accompanying drawings and dependent claims.

### BRIEF DESCRIPTION OF THE DRAWINGS

The subject matter according to the present invention will be disclosed in a more detailed manner hereinafter, with reference to the accompanying drawings, where:

FIG. 1 schematically shows an end portion of a tube and a deburring device therefor, according to the present invention;

FIG. 2 shows the deburring device with a drum brush thereof being driven toward the tube end portion;

FIG. 3 shows the deburring device with a drum brush thereof contacting the end portion of the tube to be deburred;

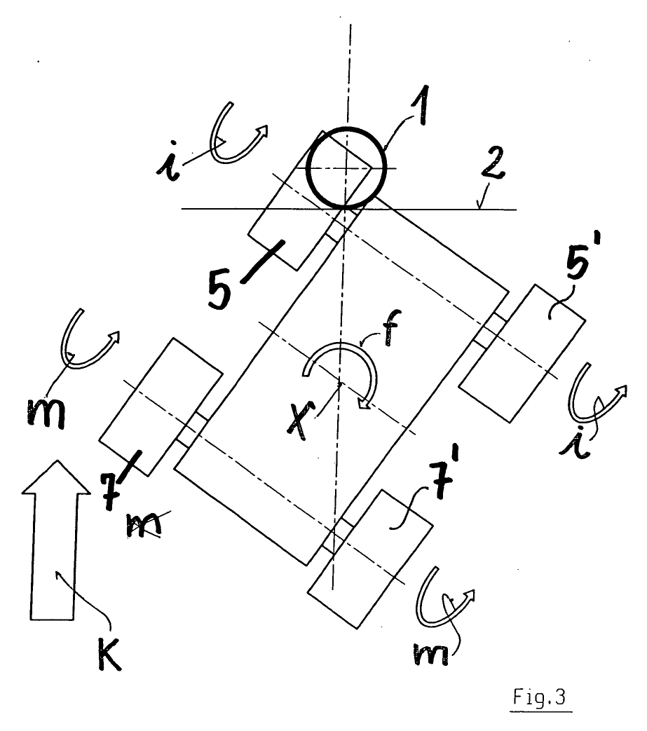

FIG. 4 shows the end portion of the tube integrally affected by the drum brush; and

FIG. 5 shows the deburring device at the end of the deburring operation.

### DESCRIPTION OF THE PREFERRED EMBODIMENT

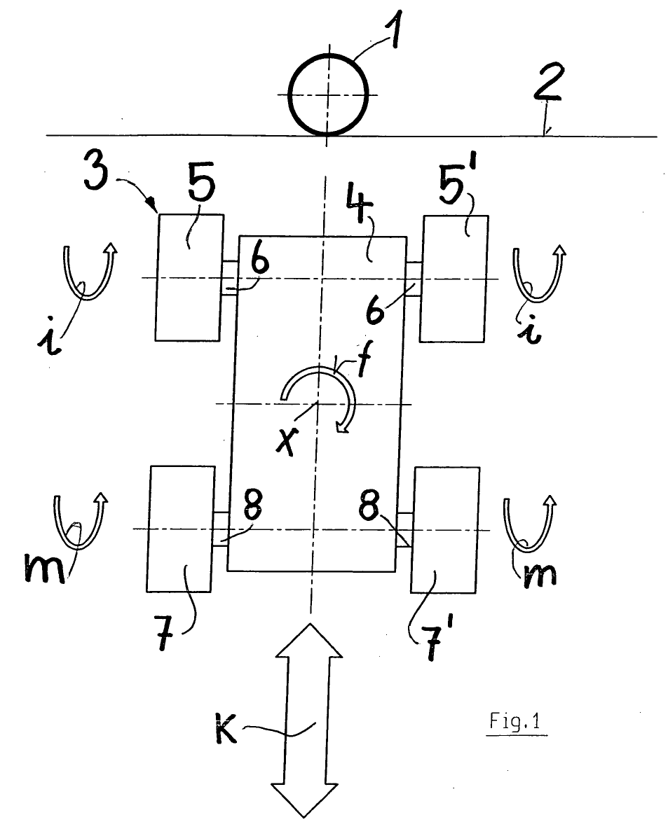

As shown in FIG. 1, a tube 1, supported on an advantageously horizontal bearing surface, is arranged on a deburring device generally indicated by the reference number 3.

Said deburring device 3 comprises a support body 4 rotatively driven (arrow f) about a horizontal pivot axis X perpendicular to the drawing sheet plane.

At both sides of the rotary supporting body 4 are arranged a pair of drum brushes 5 and 5′, supported by a supporting shaft 6 rotatively driving said drum brushes 5 and 5′ in the direction shown by the arrows (i).

A further shaft 8 supports, at end portions thereof, another pair of rotary brushes 7, 7′.

In particular, the rotatively driven support body 4 supports drum brushes 7, 7′ having a pivot axis parallel to the shaft or axis 6, and adapted to be rotatively driven in the direction of the arrows (m).

The thus designed brushing or deburring device 3 can be generally driven parallel to the drawing sheet, to respectively move toward/away from the tube 1, as shown in FIG. 1 by the bidirectional arrow (k).

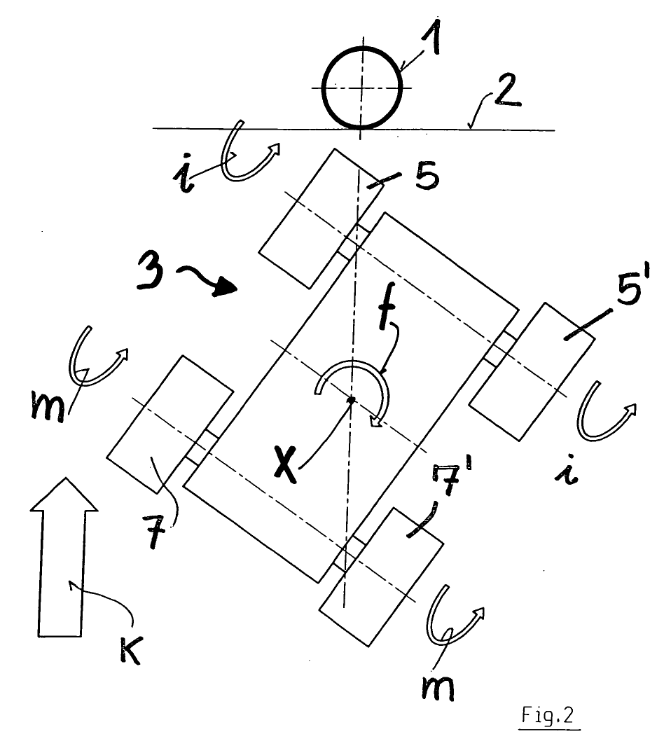

FIG. 2 shows the tube 1 supported on a supporting surface 2, together with said device 3, including said rotary drum brushes 5, 5′ 7, 7′ (arrow i), which are rotatively driven (arrow f) about the pivot axis X and so translated (arrow K) as to approach the end portion of the tube 1.

In particular, upon a continued raising movement (arrow K), as shown in FIG. 2, the rotary drum brush 5 will contact the end portion of the tube 1, thereby subjecting said end portion to a strong deburring operation, in the direction shown by the arrow (i).

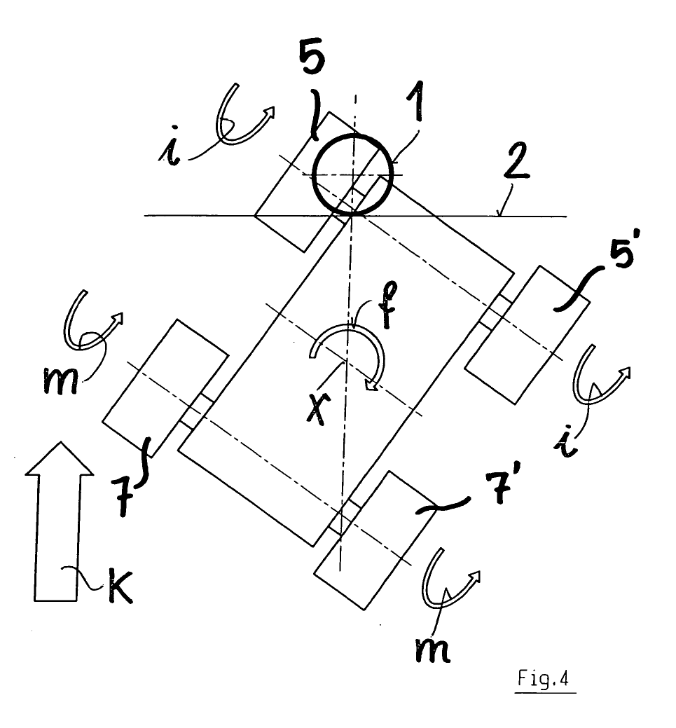

FIG. 4 shows the tube 1 still supported on the supporting surface 2 and with its front surface also brushed by the rotary drum brush 5 in the direction of the arrow (i).

Thus, due to the raising movement K of the supporting body 4 and also due to said rotary movement (f) of said supporting body 4 about its pivot axis X, the brushing trajectory or direction of the rotary drum brushes 5, 5′, 7, 7′ with respect to the end portion of the tube 1 will be continuously changed thereby providing an improved deburring or brushing effect on the end portion of the tube 1.

Moreover, said brushes 5, 5′ and 7. 7′ will wear in a gradual and even manner, thereby preventing any deformations of said brushes.

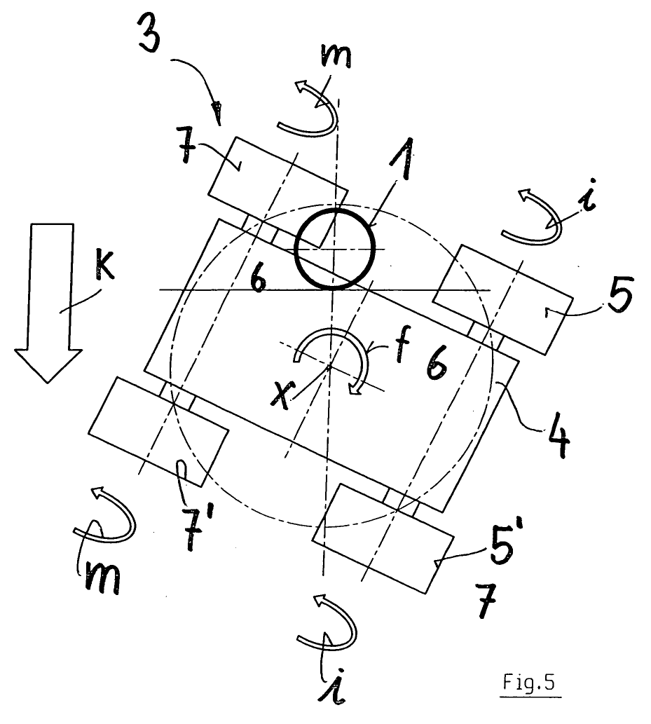

FIG. 5 shows the rotary drum brush 5 moved away from the end portion of the tube 1 at the start of the lowering movement K of the device 3.

Advantageously, the movements K, e and f being performed with a rate which can be easily adjusted depending on the shape and material of the tube 1.

1. A device for deburring end portions of tubes (1) arranged in a horizontal plane (2), characterized in that said device comprises a supporting body (4) rotatively driven about a pivot axis (X), said supporting body (4) supporting pairs of rotary drum brushes (5, 5′; 7, 7′) rotatively driven about a drum brush pivot axis (6, 8) perpendicular to said pivot axis (X) of said support body (4), and that said support body (4) and drum brushes (5, 5′; 7, 7′) are controllably translated in a plane coinciding with an end portion of a tube (1) to be deburred.

2. A device, according to claim 1, characterized in that said support body (4) comprises, on both sides thereof, a pair of drum brushes (5, 5′; 7, 7′), supported by a respective shaft (6; 8) rotatively driving said drum brushes (5, 5′; 7, 7′).

3. A device, according to claim 1, characterized in that said deburring brush (5, 5′; 7, 7′) supporting body (4) is so controllably translated (K) as to be moved toward respectively away from said end portion of said tube (1).

4. A device, according to claim 1, characterized in that the motion (K, i, f) rates are adjustable.
